(19) United States
(12) Patent Application Publication
(10) Pub. No.: US 2012/0016710 A1
(43) Pub. Date: Jan. 19, 2012

(54) SIMULATING SUPPLY AND DEMAND REALIZATION IN WORKFORCE PLAN EVALUATION

(76) Inventors: Cipriano A. Santos, Modesto, CA (US); Jerry Z. Shan, Palo Alto, CA (US); Maria T. Gonzalez Diaz, Mountain View, CA (US); Shailendra K. Jain, Cupertino, CA (US)

(21) Appl. No.: 13/260,261

(22) PCT Filed: Feb. 23, 2010
(86) PCT No.: PCT/US10/25099

§ 371 Date: Sep. 24, 2011

(51) Int. Cl. G06Q 10/00

(52) U.S. Cl. 705/7.22; 705/320

(57) ABSTRACT

A method of workforce plan evaluation includes receiving (110) a resource data (440) that includes data relating to employee resources, and data relating to a set of opportunities representing demand for employee resources; and receiving a workforce plan (450) associated with the resource data. A realization model configured to simulate effects of supply and demand uncertainty on the resource data is established (130) and executed (140) over a given time period (240) of the planning window (230) for which the workforce plan (450) is generated. The resource data (440) is transformed (150) according to the predictions of the resource model, and metrics configured to assess demand fulfillment and/or resource utilization achieved by the workforce plan under the realization model are computed (160).

### BACKGROUND

Business organizations with a large number of employees may engage in workforce management practices, such as to ensure adequate staffing and to increase the efficiency of employee allocation among various projects undertaken by the organization. One approach to workforce management involves generating a workforce plan that represents an optimization of a tradeoff between labor utilization and demand fulfillment, in terms of allocating labor to projects, hiring new employees, tracking training, promotions, and re-deployment of existing employees, and so forth.

A challenge in workforce management is that of predicting staffing needs despite uncertainty in future workforce supply and demand. For example, anticipated labor requirements are sometimes forecasted for opportunities which, if realized, may represent demand for employee resources at a certain time. An example of an opportunity is a new job or contract that a company is considering bidding on, or has bid on but has not yet won. Sources of demand uncertainty may include uncertainty related to how and when new opportunities will arise, whether bid opportunities will be won, and start times of projects associated with won opportunities. Sources of supply uncertainty include dynamic employee resource availability, such as from loss due to attrition, whether job offers will be accepted, and so forth.

Workforce planning is a complex undertaking in settings where many employee resources are managed in a dynamic demand environment. In such settings it may be desirable to evaluate a workforce plan, such as under the presence of demand and supply uncertainty.

### BRIEF DESCRIPTION OF THE DRAWINGS

FIG. 1 illustrates an example method associated with workforce plan evaluation, in accordance with an embodiment of the invention.

FIG. 2 illustrates an example process flow associated with workforce plan evaluation, in accordance with an embodiment of the invention.

FIG. 3 illustrates another example process flow associated with workforce plan evaluation, in accordance with an embodiment of the invention.

FIG. 4 illustrates an example system and apparatus associated with workforce plan evaluation, in accordance with an embodiment of the invention.

### DETAILED DESCRIPTION

A workforce plan is usually associated with a resource data that includes data representing employee resources available to an organization, as well as data associated with a set of opportunities that each represent potential demand for employee resources. A workforce plan may be generated, for example, by employing a mixed integer programming (“MIP”) model that includes an objective function, or by any appropriate computational method. A workforce plan may be generated by a workforce planning tool or system, the functionality of which may be embodied in executable code in a computer readable medium. The objective function may include optimizing a tradeoff between labor utilization and demand fulfillment, and may be configured to favor one or more desired goals, such as reducing employee oversupply costs, or to maintain a workforce buffer capacity, or bench, of a desired side and/or skill set, and so forth. Further, the computational method used to generate the workforce plan may be configurable, such that one or more algorithms used in the generation of the plan may be optimized, for example in light of an evaluation performed on the workforce plan. The workforce plan may include a workforce allocation plan that maps employees to jobs associated with one or more opportunities, a hiring plan to direct the number and type of job offers to be made by the organization, and so forth, and may reflect any desired goals in its recommendations. For example, an allocation plan may favor minimizing workforce cost to total demand fulfillment, a hiring plan may impose limits on job offers, for example by directing the implementation of a hiring freeze for a set duration of time, and so forth. A workforce plan may be generated for a given future planning window, sometimes referred to as a planning horizon, measured in months or some other time period. For example, a workforce plan may be generated for a planning window of three months, six months, and so forth.

One method of evaluating a workforce plan involves establishing a realization model that simulates, and thereby attempts to predict, effects of supply and demand uncertainty over time, such as over the planning window for which the workforce plan is generated. The realization model may simulate demand realization by predicting changes to the data associated with opportunities. For example, a realization model may predict a rate at which new opportunities arrive and are added to the set. A realization model may simulate supply realization by predicting changes to employee resource data. For example, a realization model may predict an attrition rate for existing employees, an arrival rate of new employees who accept job offers (made, for example according to the workforce plan), availability dates of new employees, and so forth.

A realization model may be executed over a given time period of the planning window. For example, if a workforce plan is generated for a six-month planning window, the realization model may be executed over the first month. Executing a realization model may predict a number of opportunities in the set that are won and will present a demand for employee resources, a loss and/or gain of employee resources, and so forth. If the workforce plan includes an allocation plan, a realization model may assign new employee to satisfy requirements of projects associated with opportunities predicted to have been won and start during the given time period according to the allocation plan, and satisfy replacements of employees that have left the organization. Executing a realization model may also predict a number of new opportunities to be added to the set.

A method of workforce plan evaluation may further involve transforming the resource data according to predictions of the realization model. For example, the data relating to the set of opportunities may be updated to reflect the arrival of new opportunities, and/or departure of selected opportunities associated with demands that are satisfied during the given time period, such as by replacing selected existing data with predicted data. The resource data may include a probability data relating to the selection probability of the opportunities, and the method may assign each new opportunity an initial selection probability, and/or update the selection probabilities of the existing opportunities. Selection of an opportunity may involve bidding on the opportunity, and then predicting whether the bid opportunity is won.

Some methods of workforce plan evaluation may involve multiple iterations of some steps, for example by further including receiving a new workforce plan for a successive planning window, with the new workforce plan reflecting the transformed resource data. The realization model may then be executed over a given time period in the successive planning window.

Successive planning windows may overlap, in what sometimes referred to as a rolling planning window. In a simulation realization, or simulation sample, a realization model is executed multiple times, for example over a series of successive time periods of a rolling planning window. The duration of a simulation realization, referred to as a simulation period, may be longer than the planning window for which a workforce plan is generated. For example, if a workforce plan is generated for a rolling six-month planning window, a simulation period may be twelve months. The workforce plan may be generated for a first planning window and with respect to an initial resource data, the realization model may be executed over the first time period (e.g., the first month) of the first planning window, the resource data may be transformed according to predictions of the realization model, a workforce plan may be generated for the next planning window and with respect to the transformed resource data, the realization model may be executed over the first period of the next planning window, and so on. The realization may terminate at the final planning window of the simulation period.

In a simulation scenario, a number of simulation realizations, or simulation samples, for the same simulation period may be performed. The realization model may employ a number of probability distributions and other calculations that include some degree of randomization, and thus the predictions of the realization model will vary from sample to sample. The number of realizations may be that sufficient to achieve statistical significance, for example in methods that employ an evaluation algorithm such as a Monte Carlo method, and may be a function of the relative complexity of the realization model.

A workforce plan may be evaluated under various metrics. For example, a demand fulfillment metric may assess the overall service level achieved under a workforce plan by evaluating how well the labor requirements of selected opportunities are fulfilled. A resource utilization metric may assess the billed resource utilization achieved under a workforce plan by evaluating the percentage of resources allocated to projects with respect all resources available. The accuracy of such evaluations may relate to the number of simulations performed. Some methods of workforce plan evaluation may accordingly include computing metrics that are configured to assess demand fulfillment, resource utilization, and so forth, achieved by the workforce plan under a realization model over a given simulation period. The metrics may then be used, for example, to configure the computational method used to generate the workforce plan.

A system of workforce plan evaluation may include a data storage subsystem configured to store a dataset that includes resource data as described above. The system may further include a processing subsystem in communication with the data storage subsystem and configured to perform various steps of the methods of workforce plan evaluation described herein.

An apparatus, such as a computer or computer network, for evaluating a workforce plan may use a dataset that includes resource data as described above. The apparatus may incorporate an establishing module that establishes a realization model configured to simulate effects of supply and demand uncertainty on the resource data. The apparatus may further include an executor that executes the realization model over a given time period of a planning window of a workforce plan associated with the resource data. The apparatus may further include a data transformer that transforms the resource data according to predictions of the realization model. The apparatus may further incorporate a computing module that computes metrics assessing one or more of demand fulfillment and resource utilization achieved by the workforce plan under the realization model.

The principles disclosed herein are discussed with respect to example systems, methods, and apparatus, and with reference to various diagrams. The example embodiments are shown and described as a series of blocks, but are not limited by this depiction or by the order presented or discussed. The actions, steps, concepts, and principles associated with the illustrated blocks may occur in different orders than as described, and/or concurrently, and fewer or more than the illustrated number of blocks may be used to implement an example method. Blocks may be combined or include multiple components or steps.

Also, many of the functional units described herein as steps, methods, processes, systems, subsystems, routines, modules, executors, data transformers, and so forth, may be implemented by one or more processors executing software. Executable code may include physical and/or logical blocks of computer instructions that may be organized as a procedure, function, and so forth. The executables associated with an identified process or method need not be physically collocated, but may include disparate instructions stored in different locations which, when joined together, collectively perform the method and/or achieve the purpose thereof. Executable code may be a single instruction or many, may be distributed across several different code segments, among different programs, across several memory devices, and so forth. Methods may be implemented on a computer, with the term “computer” referring herein to one or more computers and/or a computer network, or otherwise in hardware, a combination of hardware and software, and so forth.

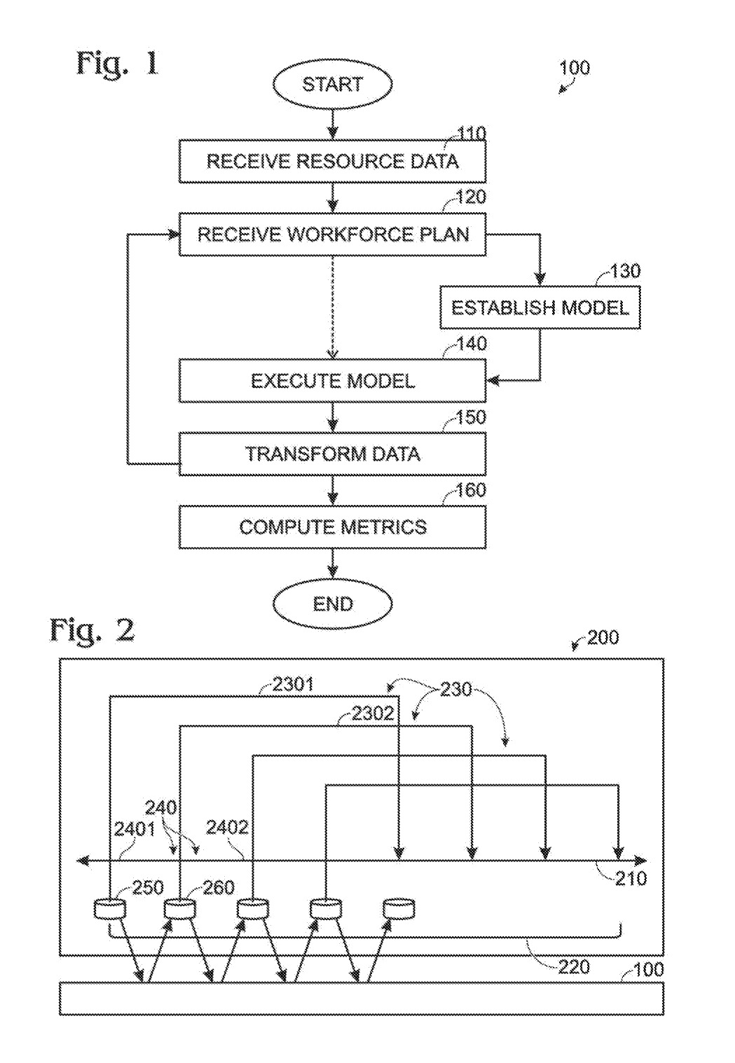

FIG. 1 illustrates an example method 100 associated with workforce plan evaluation. The method 100 may be executed on a computer. For example, the method may be stored as logic encoded on a computer readable medium which, when executed by a processor, implements the method 100. Method 100 may include, at 110, receiving a resource data. The resource data may include data relating to employee resources. The employee resources data may include definitions of employee qualifications, new employee availability dates, existing employee release dates from current projects, employee transitions (e.g. training, promotions, redeployment, etc.), employee locations and travel capabilities, and the like. The resource data may include data relating to demand for employee resources, such as actual demand of ongoing projects being serviced or staffed by the organization, or potential demand of project opportunities. The demand for employee resources data may include data relating to priority of ongoing and potential projects, opportunity cost data such as a number of jobs associated with each opportunity, start and end times for ongoing and potential jobs, job staffing and skill requirements, job locations, and so forth. Skill requirements for jobs may specify required management level, industry type, skill type, skill set, skill proficiencies, and so forth.

The set of opportunities is sometimes described as residing in a funnel. Opportunities that are selected represent actual demand for employee resources. Thus, in some embodiments, the resource data may include a probability data associated with the set of opportunities, which may describe the probability of each opportunity in the set, or funnel, of being selected. The selection process may vary based on the type of business organization. For example, selection may encompass a bidding process, in which an organization bids on an opportunity. As such, the probability data may include multiple probabilities associated with each opportunity, including a probability that the organization will bid on the opportunity, a probability of a bid opportunity being won, and so forth. Probabilities may be assigned to opportunities by resource managers or other personnel of the organization.

Method 100 may also include, at 120, receiving a workforce plan that is based, at least in part, on the resource data. The workforce plan may be generated by any appropriate computational approach, such as utilizing a MIP model. In some embodiments, the method may include generating the workforce plan, such as by utilizing a workforce planning tool.

Method 100 may also include, at 130, establishing, for example on a computer, a realization model that is configured to simulate and predict the effect of supply and demand uncertainty on the resource data over time. For convenience, the realization model may be thought of as predicting such effects over discrete time periods. For example, the realization model may predict effects that will occur in a current time period and/or in future time periods. The realization model may include a demand realization and a supply realization. The realization model may simulate demand realization by predicting, based on various probability calculations that incorporate user-defined parameters, anticipated changes to the data associated with opportunities. The demand realization may, for example, predict the arrival of new opportunities. The demand realization may further predict the selection of a number of opportunities in the funnel. Selection may include determining if a funnel opportunity is bid, and determining if a bid opportunity is won. If the resource data includes probability data that describes a selection probability of the funnel opportunities, the prediction may be based at least in part on the probability data. The demand realization may further predict whether and to what extent the probability data should be adjusted or updated over time. The demand realization may further predict when the demand for resources associated with the selected opportunities will be realized, such as during the current time period, or during a future time period.

An example approach to generating arriving opportunities may assign an arrival rate for new opportunities, such as a number of new opportunities per time period. The arrival rate may incorporate a probability distribution, such as a Poisson distribution, and/or may relate to an average arrival rate based on historical data. The approach may continue by choosing at random one of the opportunities in the set. For example, assuming there are M opportunities in the set, to define an arriving opportunity, one opportunity may be selected with probability 1/M from the set. An initial selection probability may be assigned to each arriving opportunity. The initial selection probability may be user-defined and/or may be based on historical data. This approach may further include predicting the start times of arriving opportunities, if selected. The prediction of a start time may incorporate a probability distribution such as a Bernoulli distribution, such that each opportunity may be associated with a probability of starting at a given time period, such as the current time period, or a future time period.

An example approach to predicting the selection of opportunities may consider the selection probabilities of all of the opportunities in the funnel, including arriving opportunities and existing opportunities. If selection includes bidding, a rule may be incorporated that considers the probability data, such as a rule that recommends bidding on an opportunity if its selection probability is above a certain threshold. Predicted selection may include a calculation based on the probabilities of the bid opportunities.

Establishing the demand realization may further include predicting updated probabilities for the funnel opportunities. This prediction may be configured to reflect a preference for opportunities that have been in the funnel for a given amount of time. For example, the selection probability associated with opportunities that have been in the funnel for longer than a predetermined threshold may be decreased, such as to reflect a preference for newer opportunities. A preference may be incorporated in an algorithm. For example, in each time period τ, the probability π of the funnel opportunities may be updated according to an algorithm such as the following:

$${π}_{τ} = \{ \begin{matrix}min \{ {π}_{τ - 1} + 0.15 .0 .95 \} & with Pr = 0.70 \\ {π}_{τ - 1} & with Pr = 0.20 \\ max \{ {π}_{τ - 1} - 0.10 .0 .0 \} & with Pr = 0.10\end{matrix}$$

The values of the various parameters discussed above with respect to the demand realization (e.g., threshold for bidding, probability increase and decrease values, and associated probabilities) may be user-defined.

The realization model may simulate supply realization by predicting, based on various probability calculations that incorporate user-defined parameters, anticipated changes to the data associated with employee resources. The supply realization may, for example, predict a loss rate of employee resources due to attrition, and/or a predicted gain rate of employee resources due to acceptance of job offers. The supply realization may consider a hiring plan component of the workforce plan, in predicting a gain rate, by considering the number of offers made over time. Other factors that relate to employee resource availability, such as the duration of projects to which employees may be currently assigned, size and nature of a workforce buffer capacity, and so forth, may also be considered.

In establishing the supply realization of a realization model, attrition may be predicted by associating attrition probabilities with employee resources, which may vary to reflect different job skills and skill levels possessed by employees, and so forth. The supply realization may further determine if any employees should be replaced in the same period in which they are predicted to depart, for example, by calculating the anticipated subset of departing employees that are assigned to an ongoing project.

Further, the gain rate of employee resources may be predicted by assigning a probability that a number of job offers made by the organization, for example according to a workforce plan that includes a hiring plan, will be accepted during a given time period. As with the predicted attrition rate, this probability may vary among different types of job offers to reflect variables such as the skill set and skill levels required, the predicted number of qualified applicants in the applicant pool, and so forth. The prediction may further consider whether the organization should stop, or start, making job offers according to the hiring plan, by predicting whether the anticipated number of acceptances will be sufficient to fulfill, for example, an anticipated demand for employee resources, or a workforce buffer capacity recommended by the workforce plan. The prediction may further determine when new employees will be available for assignment to jobs by assigning to each new employee an allocation availability probability for a given time period, which may further be adjusted over subsequent periods.

The values of the various parameters discussed above with respect to the supply realization (e.g., attrition probabilities, availability probability adjustment values, and associated probabilities) may be user-defined.

Method 100 may further include, at 140, executing, for example on a computer, the realization model, such as over a given time period of the planning window. The time period over which the model is executed is referred to herein as the execution period, or the current period.

Executing the realization model may include computing the predictions of the demand and supply realizations, by executing the associated probability calculations, with respect to the current time period. For example, the demand realization may predict the arrival of a number of new opportunities to the funnel, assign each arriving opportunity an initial selection probability, predict the selection of a number of opportunities in the funnel, and anticipate whether any selected opportunities represent demand for employee resources during the current period. The supply realization may predict the anticipated loss of employee resources due to attrition, whether any lost employee resources require replacement during the current period, the anticipated gain of new employee resources, and the number of new employees that will be available for allocation in the current period.

Executing the realization model may further include simulating satisfying the demand of one or more of the selected opportunities, such as those that are predicted to represent demand for employee resources during the current period, by allocating employee resources according to the workforce plan. An example approach to simulating project demand fulfillment may assign priority values to the projects to be fulfilled. For example, ongoing projects that have not yet been completely staffed may be assigned a higher priority relative to new projects associated with opportunities predicted to be selected in the current period. Headcount requirements may be fulfilled based on project priority by assigning qualified employees to jobs according to the workforce plan. For example, the workforce plan may consider the number of employees that are scheduled to complete existing assignments during the current period and rejoin the pool of available employees. The workforce plan may also direct filling certain requirements from employees on the bench, and/or recommend maintaining a bench or workforce buffer capacity of a certain size or skill set mix.

Executing the realization model may further include predicting whether any anticipated replacement requirements can be fulfilled, for example with new employees that are predicted to become available during the current period, or existing employees that are available for assignment during the current period.

Method 100 may further include, at 150, transforming the resource data according to predictions of the realization model. For example, the resource data associated with employee resources may be adjusted to reflect predicted changes, such as those due to anticipated loss and/or gain of employee resources over the execution period, anticipated employee resource availability and/or unavailability, and so forth. The resource data associated with opportunities may be adjusted to reflect predicted changes—such as by replacing existing data with predicted data—such as due to new opportunities that arrive to the funnel during the execution period, initial selection probabilities associated with the new opportunities, updated selection probabilities for funnel opportunities, and so forth, as well as removal of opportunities with fulfilled headcount requirements from the set, as well as those associated with selection probabilities of zero, and any bid opportunities that are predicted not to be won. The transformed resource data may also be referred to as a projected data, or a predicted data, or a simulation data.

The method 100 may include multiple iterations of some of the steps described herein, for example by receiving (or generating) a new workforce plan for a successive planning window, which reflects the projected data. The realization model may then be executed over a given time period of the successive planning window, the projected data may then be further transformed accordingly, and so forth for additional successive planning windows.

For example, as explained in more detail below, a simulation realization for a given simulation period may involve starting with a resource data and associated workforce plan for a planning window, executing a realization model over a given time period of the planning window and transforming the resource data accordingly, receiving a new workforce associated with the projected resource data for a successive planning window, executing the realization model over a given time period of the successive planning window, and so forth, for as many successive planning windows in the simulation period.

Further, a simulation scenario may involve performing a number of simulation realizations for the same realization period.

Method 100 may include, at 160, computing metrics configured to assess demand fulfillment and/or resource utilization achieved by the workforce plan under the realization model. One type of demand fulfillment metric may assess the overall service level achieved under a workforce plan by evaluating how well the labor requirements of selected opportunities are fulfilled. Such a metric may be calculated by summing the number of won opportunities that are predicted to be completely satisfied with the workforce plan, divided by the total number of funnel opportunities considered throughout the number of simulation realizations performed.

Another type of demand fulfillment metric may assess a fill rate achieved under a workforce plan by evaluating how well the workforce plan satisfies labor requirements of all won opportunities. Such a metric may be calculated by summing the labor requirements of won opportunities that are satisfied by the workforce plan over all time periods of a planning horizon considered throughout the number of simulation realizations performed, divided by the total labor requirements of won opportunities over the planning horizon.

Another type of demand fulfillment metric may assess a backfill rate achieved under a workforce plan by evaluating how well labor replacements due to attrition can be satisfied with respect to total labor replacements. Such a metric may be calculated by summing labor replacements due to attrition that can be satisfied over all time periods of a planning horizon considered, divided by all of the labor replacements requiring backfill over the planning horizon.

One type of utilization metric may assess the billed resource utilization achieved under a workforce plan by evaluating the percentage of resources allocated to projects with respect all resources available. Such a metric may be calculated by summing the labor requirements of won opportunities that are satisfied with the workforce plan over all time periods of a planning horizon considered, divided by the total resources available over the planning horizon.

Metrics may be computed by period, by simulation realization, over an entire simulation scenario, over selected realizations of a scenario, and so forth. Metrics may focus on a particular type of data, such as a given technology, skill group, and so forth.

Referring to FIG. 2, a diagram showing a conceptual overview of an example simulation realization 200, the simulation realization is shown to coordinate with and incorporate various aspects of the method 100. A time axis is indicated at 210. In the simulation realization 200, a simulation period 220 spans a number of overlapping planning windows 230, which, over time, define a rolling planning window. Each planning window in turn includes a number of time periods 240. Although the time periods, planning windows, and simulation period may be set to any length, for the sake of convenience, each time period 240 may represent one month, and thus each planning window 230 in the illustrated example represents four months. The initial resource data for the simulation realization, as well as the related workforce plan associated therewith, are indicated at 250. The initial workforce plan is generated for the initial planning window 230 (indicated at 2301).

At the beginning of the example simulation realization, according to method 100, the realization model is executed over the first time period (indicated at 2401) of the planning window 2301, and considers the initial resource data and associated workforce plan. The projected data that reflects the predictions of the realization model, and the new workforce plan that incorporates the projected data, are collectively indicated at 260. The new workforce plan is generated for the successive planning window (indicated at 2302) of the rolling planning window. The simulation realization continues by executing the realization model over the first time period (indicated at 2402) of planning window 2302, and so forth, until the simulation realization terminates at the first period of the final planning window of the simulation period 220.

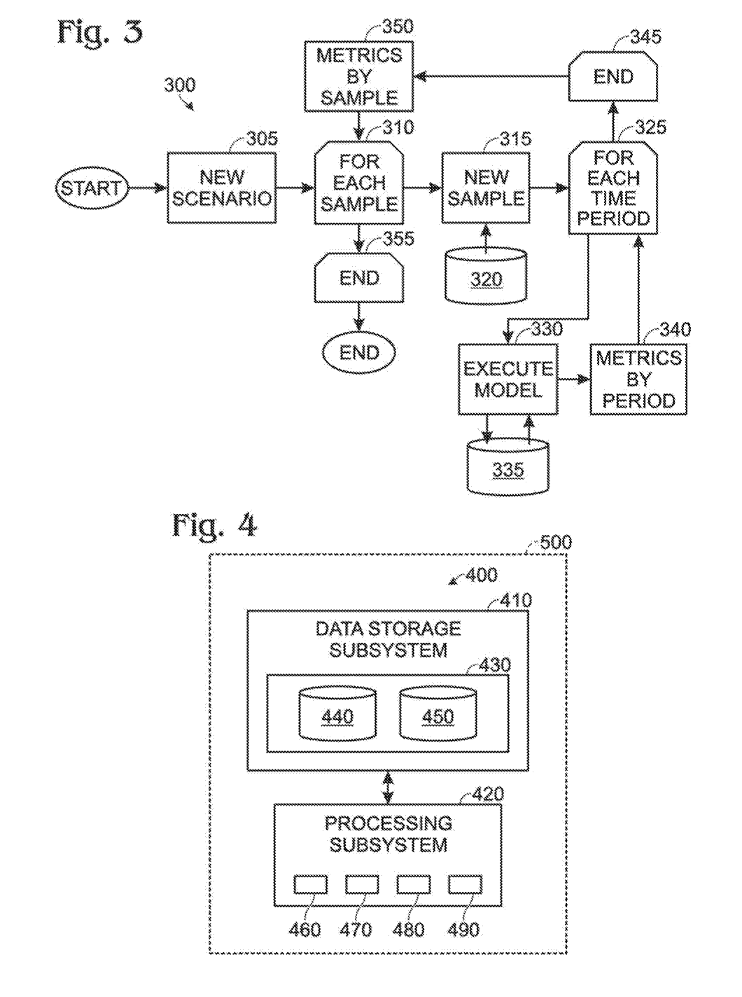

FIG. 3 shows a process flow for an example simulation scenario 300, which involves a number of simulation realizations for the same simulation period. At 305, a new simulation scenario is created, which may involve setting parameters such as the number of simulation realizations to perform, the length of the simulation period, and so forth. Creating the new simulation scenario may also include, for example, establishing the realization model, and/or setting various parameters of the model. At 310, a loop initiates for each simulation realization (or simulation sample) in the simulation scenario. The loop begins at 315 with the creation of a new simulation realization, which incorporates an initial resource data and a related workforce plan for an initial planning window, indicated collectively at 320. At 325, a nested loop initiates for each time period in the simulation realization for which the realization model will be executed. At 330, the realization model is executed, and transforms the resource data accordingly. New workforce plans are generated for the following planning window to reflect the projected data in the execution time period. The new workforce plans and projected data are collectively indicated at 335. At 340, metrics may be computed by period. At 345, the nested loop terminates at the conclusion of the simulation realization. At 350, simulation metrics may be computed. The simulation realization loop terminates at 355 at the end of the simulation scenario.

The example system 400 in FIG. 4 is shown as a block diagram that includes a data storage subsystem 410 in communication with a processing subsystem 420. The data storage subsystem 410 may be configured to store a dataset 430 that includes resource data (indicated at 440), and that may also include a workforce plan (indicated at 450) related to the resource data and generated for a given planning window. As noted above, the resource data may include data relating to employee resources, and data relating to a set of opportunities representing demand for employee resources.

The dataset 430 stored and managed in the data processing subsystem 410 may be available to the processing subsystem 420, which may be configured to perform various steps of the example method 100 disclosed above. For example, the processing subsystem may be configured to establish a realization model to simulate effects of supply and demand uncertainty on the resource data, execute the realization model over a given time period of the planning window, transform the resource data according to predictions of the realization model, and compute metrics to assess one or more of demand fulfillment and resource utilization achieved by the workforce plan under the realization model. In some embodiments, the system 400 may incorporate one or more components and/or subcomponents to perform one or more of such actions. For example, processing subsystem 420 is shown to include an establishing module 460 that establishes a realization model configured to simulate the effects of supply and demand uncertainty on a resource data, an executor 470 that executes the realization model over a given time period of a planning window of a workforce plan associated with the resource data, a data transformer 480 that that transforms the resource data according to predictions of the realization model, and a computing module 490 that computes metrics assessing one or more of demand fulfillment and resource utilization achieved by the workforce plan under the realization model. In some embodiments, these components may be thought of as collectively forming an apparatus 500 for evaluating a workforce plan using the dataset 430. Apparatus 500 may physically house the components and subsystems of system 400, as shown in FIG. 4, or may take any suitable configuration.

We claim:

1. A method, comprising:
receiving (110) a resource data that includes data relating to employee resources, and to a set of opportunities representing demand for employee resources;
receiving (120), for a planning window, a workforce plan associated with the resource data;
establishing (130), by a computer, a realization model configured to simulate and predict effects of supply and demand uncertainty on the resource data;
executing (140), by a computer, the realization model over a given time period of the planning window;
transforming (150) the resource data according to predictions of the realization model, wherein the transforming includes replacing selected data with predicted data; and
computing (160) metrics configured to assess one or more of demand fulfillment and resource utilization achieved by the workforce plan under the realization model.

2. The method of claim 1, wherein executing (140) the realization model includes predicting the selection of one or more opportunities in the set.

3. The method of claim 2, wherein executing (140) the realization model further includes predicting the selected opportunities that represent demand for employee resources during the given time period.

4. The method of claim 2, wherein the resource data further includes data relating to the probability of each opportunity being selected, and wherein the prediction is based at least in part on the selection probability of each opportunity.

5. The method of claim 2, wherein predicting the selection of one or more opportunities includes determining whether to bid on one or more opportunities, and determining whether any opportunities that have been bid on will be won.

6. The method of claim 1, wherein executing (140) the realization model includes predicting one or more of anticipated loss of employee resources in the given time period due to attrition, and anticipated gain of employee resources in the given time period due to acceptance of job offers made according to the workforce plan.

7. The method of claim 1, wherein executing (140) the realization model includes simulating satisfying demand of one or more of selected opportunities by allocating employee resources according to the workforce plan.

8. The method of claim 1, wherein transforming (150) the resource data includes adjusting employee resource data to reflect predicted changes due to one or more of anticipated loss of employee resources in the given period due to attrition, anticipated gain of employee resources in the given period due to acceptance of job offers, anticipated gained employee resource availability, and anticipated employee resource unavailability due to assignment to jobs associated with selected opportunities in satisfaction of the demand represented by said opportunities.

9. The method of claim 1, wherein executing (140) the realization model includes generating new opportunities to be added to the set.

10. The method of claim 9, wherein the resource data further includes a probability data relating to the probability of each opportunity being selected; and wherein executing (140) the realization model further includes:
assigning an initial selection probability to one or more new opportunities; and
updating the selection probabilities of existing opportunities in the set.

11. The method of claim 1, wherein the planning window is a first planning window, and wherein the method further includes repeating the receiving (110, 120), executing (140), and transforming (150) steps for a given time period of a second planning window, using the transformed resource data.

12. The method of claim 1, further comprising:
prior to receiving (110) a resource data, defining a simulation realization (200) that includes a simulation period (220) with a plurality of planning windows (230); and
performing the method of claim 1 for a given time period (240) of each of the planning windows.

13. The method of claim 1, further comprising:
prior to receiving (110) a resource data, defining a simulation scenario (300) that includes a plurality of simulation realizations (200), simulation realization (200) including a simulation period (220) with a plurality of planning windows (230); and
performing the method of claim 1 for a given time period (240) of each of the planning windows of the simulation period (220) of each simulation realization (200).

14. An apparatus (500) for evaluating a workforce plan using a dataset (430) that includes resource data (440) relating to employee resources and to a set of opportunities representing demand for employee resources, and data (450) relating to a workforce plan associated with the resource data and generated for a given planning window, the apparatus comprising:
an establishing module (460) that establishes a realization model configured to simulate effects of supply and demand uncertainty on a resource data that includes data relating to employee resources, and data relating to a set of opportunities representing demand for employee resources;
an executor that executes (140) the realization model over a given time period of a planning window of a workforce plan associated with the resource data;
a data transformer that transforms (150) the resource data according to predictions of the realization model; and
a computing module that computes (160) metrics assessing one or more of demand fulfillment and resource utilization achieved by the workforce plan under the realization model,

15. A system of workforce plan evaluation, comprising:
a data storage subsystem (410) configured to store a dataset (430) including resource data (440) relating to employee resources and to a set of opportunities representing demand for employee resources, and data (450) relating to a workforce plan associated with the resource data and generated for a given planning window; and
a processing subsystem (420) in communication with the data storage subsystem (410) and configured to:
establish (130) a realization model configured to simulate effects of supply and demand uncertainty on the resource data;
execute (140) the realization model over a given time period of the planning window;
transform (150) the resource data according to predictions of the realization model, wherein transforming includes replacing selected data with predicted data; and
compute (160) metrics configured to assess one or more of demand fulfillment and resource utilization achieved by the workforce plan under the realization model.
